(19) United States
(12) Patent Application Publication
(10) Pub. No.: US 2024/0278706 A1
(43) Pub. Date: Aug. 22, 2024

(54) Tire Inflation System

(71) Applicant: Haltec Corporation, Salem, OH (US)

(72) Inventors: Adam Shields, Salem, OH (US); Justin Gloeckner, Lisbon, OH (US); Adam Kemp, Youngstown, OH (US); James Fitzgerald, Salem, OH (US); Justin Thaler, Calcutta, OH (US)

(73) Assignee: Haltec Corporation, Salem, OH (US)

(21) Appl. No.: 18/441,424

(22) Filed: Feb. 14, 2024

Related U.S. Application Data
(60) Provisional application No. 63/446,193, filed on Feb. 16, 2023.

(51) Int. Cl. B60P 3/14; B60S 5/04

(52) U.S. Cl. CPC B60P 3/14; B60S 5/046

(57) ABSTRACT

A tire inflation system is provided comprised of a wheeled body that is comprised of a means to inflate and deflate tires using at least one inflator. The system is also comprised of a plurality of safety measures such as at least one pressure switch, and at least one emergency deflate button. The system is also comprised of at least one muffler to reduce the noise of the system during use. The system may also have at least one hose that can attach to a tire and to an air inlet/outlet of the system to facilitate inflation of the tire.

### CROSS-REFERENCE TO RELATED APPLICATION

The present application claims priority to, and the benefit of, U.S. Provisional Application No. 63/446,193, which was filed on Feb. 16, 2023, and is incorporated herein by reference in its entirety.

### FIELD OF THE INVENTION

The present invention relates generally to the field of tire inflation devices. More specifically, the present invention relates to a relates to a system that can be used to inflate and deflate the off-road tires of mining vehicles and other heavy machinery. Even more specifically, the invention is comprised of a mobile system primarily comprised of at least one wheel, at least one air inlet and outlet, at least one venturi, at least one pressure switch, at least one pneumatic control system, at least one inflator, at least one muffler, and at least one control. Accordingly, the present disclosure makes specific reference thereto. Nonetheless, it is to be appreciated that aspects of the present invention are also equally applicable to other like applications, systems, and methods of manufacture.

### BACKGROUND

Servicing the tires of mining vehicles, as well as other types of heavy equipment vehicles, is often recognized as a particularly time-intensive and intricate process. This is especially true given the substantial size, weight, and durability required of the tires to withstand the harsh conditions of mining operations and other heavy-duty tasks. The extended duration required to service these tires can result in significant operational downtime, leading to potential monetary loss for businesses engaged in mining or similar operations where time is of the essence.

The majority of the tire service time is consumed by tasks directly related to managing the tire pressure, specifically the inflation and deflation of the vehicle's tires. This is a critical aspect of vehicle maintenance, as proper tire pressure is essential for ensuring the safety, efficiency, and longevity of the tires under extreme operational conditions. Inflation and deflation must be performed with precision and care, considering the unique specifications of each tire and vehicle type.

Therefore, there exists a long-felt need in the art for a system that can be used on a tire. There also exists a long-felt need in the art for a mobile inflation and deflation system for off-road tires that reduces the field service time of large tires. More specifically, there exists a long-felt need in the art for a mobile inflation and deflation system for off-road tires that allows a user to efficiently, reliably, and safely inflate and deflate a tire faster than manual inflation/deflation. Further, there exists a long-felt need in the art for a mobile inflation and deflation system for off-road tires that allows a user to efficiently, reliably, and safely deflate a tire, wherein the system is mobile.

The subject matter disclosed and claimed herein, in one embodiment thereof, comprises a tire inflation system. The system is comprised of a wheeled body that is comprised of a means to inflate and deflate tires using at least one inflator. The system is also comprised of a plurality of safety measures such as at least one pressure switch, and at least one emergency deflate button. The system is also comprised of at least one muffler to reduce the noise of the system during use. The system may also have at least one hose that can attach to a tire and to an air inlet/outlet of the system to facilitate inflation of the tire.

In this manner, the tire inflation system of the present invention accomplishes all the forgoing objectives and provides a device that reduces the field service time of large tires. More specifically, the device allows a user to efficiently, reliably, and safely inflate and deflate a tire faster than manual inflation/deflation. While doing so, the system is mobile and can be easily transported.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tire inflation system designed for versatility and efficiency in managing tire pressure. The system is comprised of at least one inflator and a venturi mechanism for creating suction, facilitating tire deflation by increasing air velocity. A muffler is integrated to reduce noise during operation, while solenoid-actuated valves allow switching between inflation and deflation modes. Pressure switches and sensors monitor tire pressure, ensuring safety by preventing excessive pressure buildup. The system can be either stationary or mobile, equipped with wheels for easy transportation, and features such as a towing hitch and a durable body construction for stability and vibration resistance. Air inlet and outlet ports accommodate hoses for connection, and a gauge measures pressure in various system parts. Indicator lights provide status updates on pressure levels, and an emergency deflate button offers quick pressure release. Additionally, the system is comprised of a toolbox, power inlet, and control buttons for user convenience.

Accordingly, the tire inflation system of the present invention is particularly advantageous as it provides a device that reduces the field service time of large tires. More specifically, the device allows a user to efficiently, reliably, and safely inflate and deflate a tire faster than manual inflation/deflation. While doing so, the system is mobile and can be easily transported. In this manner, the tire inflation system that provides a solution to inflating vehicle tires.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a tire inflation system of the present invention in accordance with the disclosed architecture;

FIG. 2 illustrates a side view of an interior of one potential embodiment of a tire inflation system of the present invention in accordance with the disclosed architecture;

FIG. 3 illustrates a side view of an exterior of one potential embodiment of a tire inflation system of the present invention in accordance with the disclosed architecture;

FIG. 4 illustrates a side perspective view of an interior of one potential embodiment of a tire inflation system of the present invention in accordance with the disclosed architecture; and

FIG. 5 illustrates a side view of a tool of one potential embodiment of a tire inflation system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and systems are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that can be used on a tire. There also exists a long-felt need in the art for a mobile inflation and deflation system for off-road tires that reduces the field service time of large tires. More specifically, there exists a long-felt need in the art for a mobile inflation and deflation system for off-road tires that allows a user to efficiently, reliably, and safely inflate and deflate a tire faster than manual inflation/deflation. Further, there exists a long-felt need in the art for a mobile inflation and deflation system for off-road tires that allows a user to efficiently, reliably, and safely deflate a tire, wherein the system is mobile.

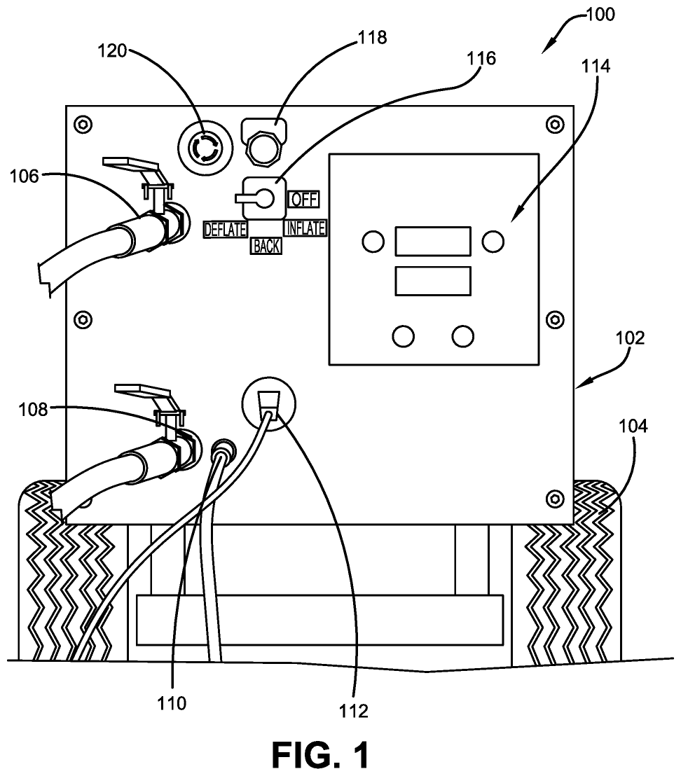

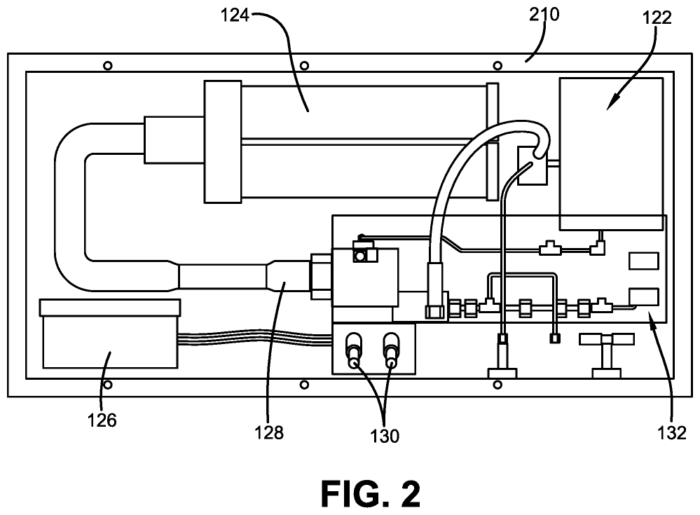

Referring initially to the drawings, FIG. 1 illustrates a front view of one potential embodiment of a tire inflation system 100 of the present invention in accordance with the disclosed architecture. The system 100 is comprised of a plurality of components. The system 100 is comprised of at least one inflator 122. The inflator 122 is preferably an OTR inflator with a ¾″ valve block, but it may be any type. The system 100 is also comprised of at least one venturi 128 (as seen in FIG. 2) that creates a vacuum within the system 100 to allow the system 100 to create suction with a tire during use. More specifically, the venturi 128 creates pressurized flow and creates a vacuum by creating a choke in the system. This area change results in an extreme increase in the velocity of the air pressure causing the tire air flow to be sucked out of the tire.

The system 100 also has at least one muffler 124. The muffler 124 is used to dampen the noise of the system 100 during use. More specifically, the muffler 124 dampens noise while the system 100 is deflating a tire.

The system 100 may also have at least one solenoid-actuated valve 170. The valve allows a user to switch between the inflation and deflation functions of the system 100. Further, at least one pressure switch 130 indicates unsafe pressure within a tire being used with the system 100 and ensures the bead seat cannot exceed unsafe seating pressure. Unsafe pressure may also be measured by at least one pressure sensor 180 and indicated by at least one indicator light 154.

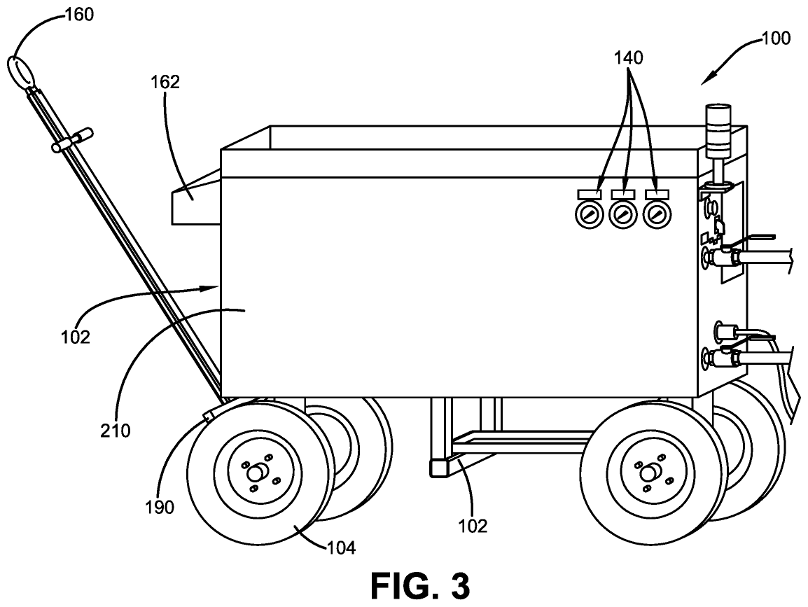

The system 100 may be stationary in one embodiment. In another embodiment, the system 100 is mobile and is comprised of at least one wheel 104, as seen in FIG. 3. The wheel 104 is preferably a tubeless rubber wheel with shock-resistant capabilities. The wheel 104 may also be comprised of a crossbar towing brake 190. The body 102 of the system 100 is preferably made from a square tubing and may also be comprised of a Lunette ring towing hitch 160. The system 100 may be comprised of a mounting plate 200 fastened to the body 102 with chariot bolts and nylock nuts to ensure stability and vibration-resistant to prevent loosening.

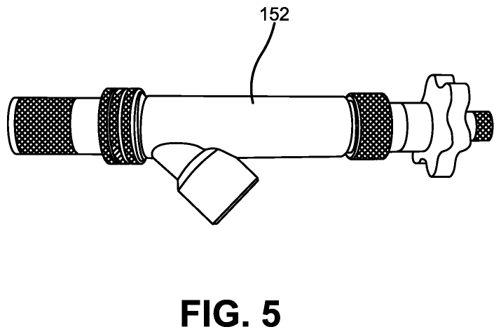

The system 100 has at least one air inlet 106 and one air outlet 108 that allows various hoses 150 to attach to the system 100. The system 100 may have at least one gauge 140 that measures the pressure (preferably in Psi) from the inlet 106, outlet 108, and/or muffler 124. The system 100 may also have at least one air hose 150 that is preferably (but not limited to) at least 20′ in length. The hose 150 preferably has a thread-on valve core removal tool 152 (as seen in FIG. 5) that can be attached to a tire prior to deflation. The hose 150 may attach to the inlet 106 and outlet 108 structures of the system 100 via at least one connector 151 of any type. The connector 151 may be comprised of at least one valve 1510 (such as but not limited to a ball valve) that can be opened/closed while inflating/deflating using the system 100.

The interior of the body 102 (as seen in FIG. 2) is preferably protected via 12-gauge steel panels 210 that separately fasten together and attach to the body. The electrical controls 114 of the system 100 are mounted on a back panel to ensure debris generated from towing the system does not damage the internal components.

The pneumatic control system 132 is preferably a Swagelok pneumatic control system made from leak-tested and 200 psi 316 stainless steel tubing and valves. The system 132 is mounted within the body 110 using an angle iron mount 220 that provides rigidity.

The system 100 may have at least one indicator light 154. In one embodiment, the system has a red indicator light 154 and a green indicator light 154. The red indicator light 154 indicates a stable pressure has exceeded a threshold value, such as but not limited to 5 psi. The green indicator light 154 indicates that pressure is below a threshold value, such as but not limited to 15 psi. When stable pressure is met, the green indicator light 154 will turn off when pressure is below 5 psi. The system 100 may also have at least one emergency deflate button 120. When pressed, the button 120 automatically switches to deflation mode and purges built-up pressure within the tire being used with the system 100 through the muffler 124. The system 100 also has at least one pressure switch 130 that limits bead seating pressure to ensure an open-air inflation cycle cannot exceed standard bead seat pressure, such as but not limited to 50 psi. Further, the system 100 constantly gauges pressure and then allows for the release of air when sensing back pressure or pressure from the tire.

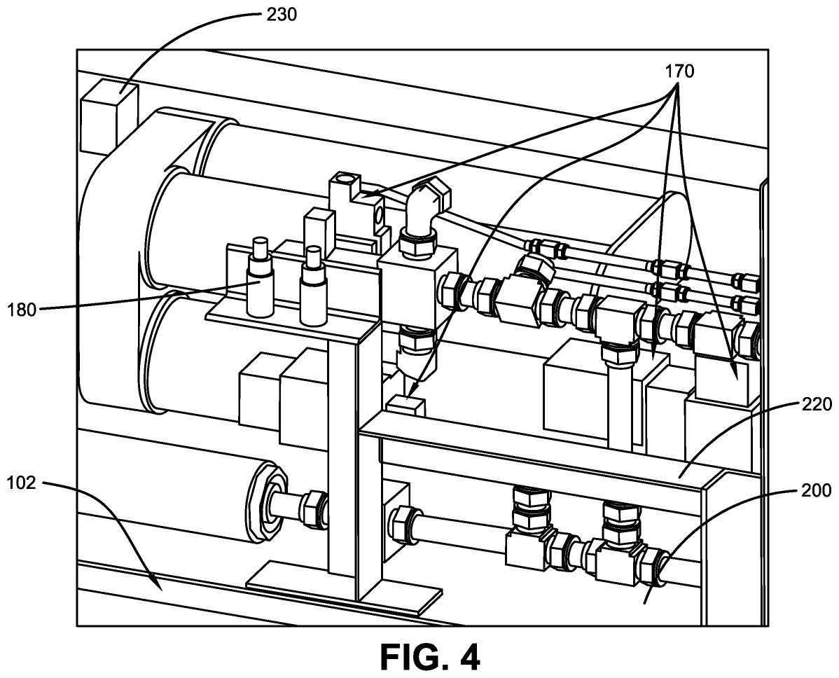

The system 100 may also be comprised of a toolbox 162, a power inlet 112 (such as but not limited to a 120V electrical hookup), a pressure pilot line 110, a plurality of inflation/deflation controls 114, a selector switch 116 to select between inflation and deflation, a start button 118 to begin an inflation/deflation cycle, and an electric control box 126. The body 102 of the system 100 may be powder-coated yellow for safety. The system 100 may also have secondary pressure gauges 140. The gauges 140 may display readings regarding compressor pressure, tank or OTR tire pressure, muffler back pressure, etc. During use, the system 100 gauges pressure when attached to a tire. This provides a stable pressure reading. The system 100 may also close an open-air inflation cycle and switch to a gauged inflation cycle during use. The device 100 may also be comprised of at least one battery 230, as seen in FIG. 4. The battery 230 is capable of AC power connection. The battery 230 may be comprised of an onboard 12V battery-powered energy source and charging system so that the device 100 can be used without AC power to enable mobile and or remote use of the system.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tire inflation system” and “system” are interchangeable and refer to the tire inflation system 100 of the present invention.

Notwithstanding the forgoing, the tire inflation system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the tire inflation system 100 as shown in the FIGS. are for illustrative purposes only, and that many other sizes and shapes of the tire inflation system 100 are well within the scope of the present disclosure. Although the dimensions of the tire inflation system 100 are important design parameters for user convenience, the tire inflation system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tire inflation system comprising:
a body comprised of:
a wheel;
an air inlet;
an air outlet;
a power inlet;
a control;
an inflater;
a venturi;
a gauge;
an indicator light; and
a pneumatic control system.

2. The tire inflation system of claim 1 wherein the inflator is comprised of an OTR inflator.

3. The tire inflation system of claim 1 further comprised of a muffler.

4. The tire inflation system of claim 1 further comprised of a solenoid-actuated valve.

5. The tire inflation system of claim 1 further comprised of a pressure switch.

6. The tire inflation system of claim 1 further comprised of a pressure sensor.

7. A tire inflation system comprising:
a body comprised of:
a wheel;
an air inlet;
an air outlet;
a power inlet;
a control;
an inflater;
a venturi;
a gauge;
an indicator light; and
a pneumatic control system; and
a hose comprised of a connector and a valve.

8. The tire inflation system of claim 7, wherein the wheel is comprised of a crossbar towing brake.

9. The tire inflation system of claim 7 further comprised of a towing hitch.

10. The tire inflation system of claim 7, wherein the hose is comprised of a thread-on valve core removal tool.

11. The tire inflation system of claim 7, wherein the body is comprised of a steel panel.

12. A tire inflation system comprising:
a body comprised of:
a wheel;
an air inlet;
an air outlet;
a power inlet;
a control;
an inflater;
a venturi;
a battery;
a tool box
a gauge;
a first indicator light; and
a pneumatic control system; and
a hose comprised of a connector and a valve.

13. The tire inflation system of claim 12, wherein the first indicator light is comprised of a red light that indicates that a stable pressure has exceeded a first threshold value.

14. The tire inflation system of claim 13, wherein the first threshold value is 5 psi.

15. The tire inflation system of claim 12 further comprised of a second indicator light.

16. The tire inflation system of claim 14, wherein the second indicator light is comprised of a green light that indicates that pressure is below a second threshold value.

17. The tire inflation system of claim 16, wherein the second threshold value is 15 psi.

18. The tire inflation system of claim 12 further comprised of a power inlet.

19. The tire inflation system of claim 12 further comprised of a secondary pressure gauge.

20. The tire inflation system of claim 12 further comprised of a pressure pilot line.
